(19) United States
(12) Patent Application Publication
(10) Pub. No.: US 2009/0119962 A1
(43) Pub. Date: May 14, 2009

(54) METHODS AND APPARATUSES FOR THE DISPLAY OF PROMOTIONAL IMAGES

(76) Inventor: Bruce De La Cruz, Cupertino, CA (US)

Correspondence Address: MOORE PATENTS, 794 LOS ROBLES AVENUE, PALO ALTO, CA, 94306-3159, US

(21) Appl. No.: 12/169,896

(22) Filed: Jul. 9, 2008

Related U.S. Application Data
(60) Provisional application No. 60/987,767, filed on Nov. 13, 2007.

(51) Int. Cl. G09F 23/00; B65D 90/00; B65F 1/00

(52) U.S. Cl. 40/616; 40/607.14; 220/694; 40/618

(57) ABSTRACT

Methods and apparatuses for the display of promotional images are provided wherein a promotional image is displayed on a waste receptacle.

### CROSS REFERENCE TO RELATED APPLICATIONS

This application claims priority to U.S. Provisional Application No. 60/987,767, filed on Nov. 13, 2007, incorporated by reference herein in its entirety.

### FIELD OF THE INVENTION

The present invention generally relates to methods and apparatus for the display of promotional materials.

### BACKGROUND OF THE INVENTION

Promotional materials with logos, slogans, and the like are widely used by organizations to promote pride, team spirit and causes of all sorts. Examples of such organizations include sports teams; schools; colleges and universities; churches; clubs; companies; departments; political parties, candidates, and issues; interest groups and causes; and so on. There are many companies that specialize in producing products that are used by these organizations for promotional purposes. Examples of products that are available include posters; T-shirts and clothing of all sorts; mugs, glasses, plates, and other food containers; bumper stickers and window stickers; buttons; pens and pencils; clocks; and many more. Typically, the product is imprinted with a logo, slogan, and/or name or message together with colors or designs associated with the subject organization. Promotional departments, marketing organizations, and others responsible for spirit, advertising, and promotion are always looking for new media on which to display their message.

One specific example of a promotional product is illustrated in U.S. Design Pat. No. D317,254 by Dembiczak et al. In this example, plastic bags such as those that can be used for the collection of leaves in the fall are decorated with the image of a pumpkin so that a full bag can present the image of a giant pumpkin.

### SUMMARY OF THE INVENTION

The present invention addresses the need and demand for new apparatuses and methods for promotion by displaying a promotional image on waste receptacles such as trashcans, recycle bins, and dumpsters. The promotional image is unrelated to the use of the waste receptacle for the storage or transfer of waste material. The invention relates both to the apparatuses used to display promotional images and to methods of promotion. In some embodiments, the promotional image is an integral part of said waste receptacle. The promotional image can be molded or embossed into the material of the waste receptacle or printed or painted onto the surface.

In other embodiments one or more display pockets are molded into or affixed to the waste receptacle, and the promotional image is displayed by inserting the promotional material into the display pocket such that the promotional image is visible from outside the pocket. The promotional image can be displayed on one or more sides or on the top or lid of the waste receptacle, or combinations thereof.

The waste receptacle can be of a size suitable for use by an individual household, house, townhouse, apartment, or condominium. It can also be of a size suitable for a collection of households or a business or construction site. As such it can be a dumpster. The display pocket can be affixed to the waste receptacle by any means such as adhesives, welds, screws, bolts, rivets, clips, hooks, wire, string, or rope.

Accordingly, there is also provided a method of promotion, comprising displaying a promotional image on a waste receptacle. The promotional image is unrelated to the storage or transfer of waste material. The method of displaying a promotional image can comprise providing a display pocket molded into or affixed to the waste receptacle and inserting promotional material into said display pocket, wherein said display sheet is visible from outside said pocket. In other embodiments, the promotional image is an integral part of said waste receptacle, for example, the promotional image can be molded or embossed into the material of said waste receptacle, or printed or painted onto the surface of said waste receptacle.

### BRIEF DESCRIPTION OF THE DRAWING

FIG. 1 shows one embodiment of a waste receptacle displaying a promotional image.

### DETAILED DESCRIPTION OF THE INVENTION

### I. Overview

Waste receptacles such as trashcans and recycle bins are typically used in most communities to provide a convenient set of containers to accumulate and sort waste materials from households, apartments, and commercial buildings for periodic pickup by a waste management and/or recycling service. In many communities, for example, pickups occur weekly. Individual users can keep their cans and bins in a hidden or enclosed location for most of the week, but typically put them out at the street for the weekly pickups. At that time, they are on prominent public display.

Up to now, the only markings on waste receptacles have been either labels or imprints identifying the manufacturer or distributor of the can or bin, or alternatively labels or imprints identifying the service that performs the periodic pickups, or the items that may be placed in the receptacle. No one has previously conceived of the idea of using waste receptacles for displaying promotional images that are unrelated to the intended use of the receptacles for containing and transferring trash and recycling. An objective of the present invention is to provide such a promotional use and thereby to provide a new platform for promotion.

### II. Definitions

Before the present invention is described in detail, it is to be understood that unless otherwise indicated this invention is not limited to specific waste receptacles, nor to specific displayed information as such may vary. It is also to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference to “a waste receptacle” includes two or more waste receptacles; reference to “an image” includes two or more images, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges can independently be included in the smaller ranges, and are also encompassed within the invention, subject to any specifically excluded limit in the stated range. Where the stated range includes one or both of the limits, ranges excluding either or both of those included limits are also included in the invention.

Specific words and phrases are generally used herein with their common English meaning as appropriate to the local context. Specific important words and phrases are further clarified as follows:

Promote: to support or provide active encouragement for the furtherance of, or so as to increase sales or public awareness of, a subject (e.g., affiliation, cause, belief, organization, movie, team, etc., without limitation).

Promotion: the act of promoting by displaying a promotional image.

Advertising: promotion as applied to a specific product or service.

Pride: a positive feeling with respect to a subject (e.g., organization, country, person, movie, team, religious affiliation, etc., without limitation). Team spirit is a form of pride, for example. Pride can be the subject of promotion.

Logo: a symbol or other design adopted by an organization denoting and/or connoting identity. Logos are displayed to identify the organization, its products, and its property.

Promotional image: a two- or three-dimensional image containing photographs, drawings and/or text, associated with the subject to be promoted. As used herein, the term “promotional image” is unrelated to the storage or transfer of waste material, and hence does not promote any waste management company or particular recycling protocol. Particular colors and symbols associated with the subject can be utilized in a promotional image (for example, “team colors,” logos). A promotional image can, without limitation, be printed or painted directly on a surface, molded into a surface, or separately manufactured and inserted into a pocket attached to a surface. The image can further be static or incorporate moving or changing features such as parts which move in the wind. The promotional image can be under machine control, such as video images, slide shows and the like. The image is normally of a size that is big enough to be readily seen at a viewing distance typical for the location of the image, but to the extent that such viewing distance can vary significantly, the size of the image can also vary, and images of multiple sizes can be displayed. Similarly, while a single image can be appropriate in some applications, multiple images or multiple copies of an image can be displayed to facilitate viewing from varied points of view or to accommodate varied positioning of the surface displaying the image.

As used herein, the phrase “promotional image displayed thereon” means that the promotional image is not a poster or printed image mounted directly to the waste receptacle without the use of a pocket, for example, attached to the waste receptacle by adhesive.

Waste receptacle: a rigid or semi-rigid container designed primarily to hold trash and/or material to be recycled. Trash and/or material for recycling are referred to herein generically as “waste.” Such containers can range in size depending on the specific intended use; examples include containers ranging from small waste baskets to trash cans and recycle bins to dumpsters. Note that a plastic bag is not a waste receptacle as that term is used herein. Plastic bags are often used to line waste receptacles, and are sometimes used without waste receptacles to hold and transport waste material, but they do not constitute waste receptacles in and of themselves. Receptacles can vary in cross-sectional shape in a horizontal plane. Typical receptacle cross-sections are either round (i.e., the receptacle is substantially cylindrical) or substantially rectangular (often with rounded corners) and can include irregularities such as grooves, ridges, handles, and the like which add strength and/or assist with handling and emptying the waste receptacles. References to the “side” or “sides” indicate the approximately vertically oriented surfaces of the receptacle. While a cylindrical receptacle has only one “side” in a strictly geometric sense, for the present purposes, the term “side” is to be broadly construed to allow for a multiplicity of sides as separate locations for displaying promotional images.

Weatherproof: resistant to damage by water, wind, and/or sun, such as may typically be caused by exposure in an outdoor environment during normal variations in seasonal weather, preferably for a period of at least several months. Some gradual degradation of material and/or fading of colors is acceptable as long as functionality and appearance is not seriously impacted.

Integral: A feature is “integral” to an object if it forms a part of the object in the sense that it cannot be readily detached. Coatings and paintings are integral, but parts which are glued or fastened on with welds, rivets, or screws are not. In the phrase “promotional image is an integral part of said waste receptacle,” the promotional image is “an integral part of” in the sense that it is a permanent feature of the waste receptacle that cannot readily be detached.

### III. Description

The present invention discloses methods and apparatuses for the display of promotional materials. These methods and apparatuses make use of waste receptacles, preferably those that are designed to be placed, at least periodically, in a public place such as a street, alley, or parking lot. Examples include trashcans and recycling bins of from about 10 to about 80 gallons capacity suitable for use by an individual household (house, townhouse, apartment, or condominium), as well as larger containers such as the dumpsters that are often used by businesses, apartment buildings, construction sites, and other locations where pickups are infrequent compared to the rate of waste generation, or large volumes of waste are generated, or both. The details of usage patterns can vary according to local geography, pickup schedules, and customs. In some cases, the waste receptacles are located such that they are on constant public display, always visible to passers-by. In other cases, they can remain in an enclosed space, accessed infrequently either to add waste or to empty the receptacles for disposal or recycling. A very common pattern of usage is that the receptacles are kept in a more or less private space for about six days out of the week and then placed in a public location such as a street curb for about one day per week for pickup. In some cases, pickup schedules can be more or less frequent, or the user can personally transport containers to a landfill, transfer station, and/or recycling center. In preferred embodiments, the receptacles are placed in a public place for at least part of the time.

However, just as people will buy a logo product such as a coffee mug entirely for personal use, public display is not a requirement. A sports fan, for example, could choose to support his favorite team with his team name, logo, slogan, and/or colors affixed to his trashcan even if his can is not routinely placed in public view for trash pickup. Further, although preferred embodiments of the invention include one or more waste receptacles that are also used for containing and transporting waste, the methods of the invention can also be practiced without ever using the receptacles to contain waste material. For example, one or more devices made according to an embodiment of the present invention can be used solely for a promotional display.

There are many specific hardware configurations that can be used to practice the invention. Specific preferred embodiments are described herein, but it should be understood that the invention is not limited to any specific embodiment in terms of receptacle size or material, any specific promotional image medium or imprinting method (whether durable and weatherproof or not), any specific means of affixing or molding a display pocket or embedding an integral promotional image to a waste receptacle, or any specific promotional application. However, when the promotional image is in the form of a printed image on paper or other substrate, the promotional image is placed in a display pocket for display, and not directly attached to the waste receptacle (for example by adhesive or double sided tape), as such direct attachment can result in soiling or damage.

Accordingly, in one embodiment, there is provided an apparatus for displaying promotional material, comprising a waste receptacle and a promotional image displayed thereon. In one embodiment, the promotional image is an integral part of the waste receptacle. In another embodiment, the waste receptacle comprises one or more display pockets molded into or affixed to the waste receptacle. The promotional image is displayed by inserting the promotional material into the display pocket such that the promotional image is visible from outside said pocket.

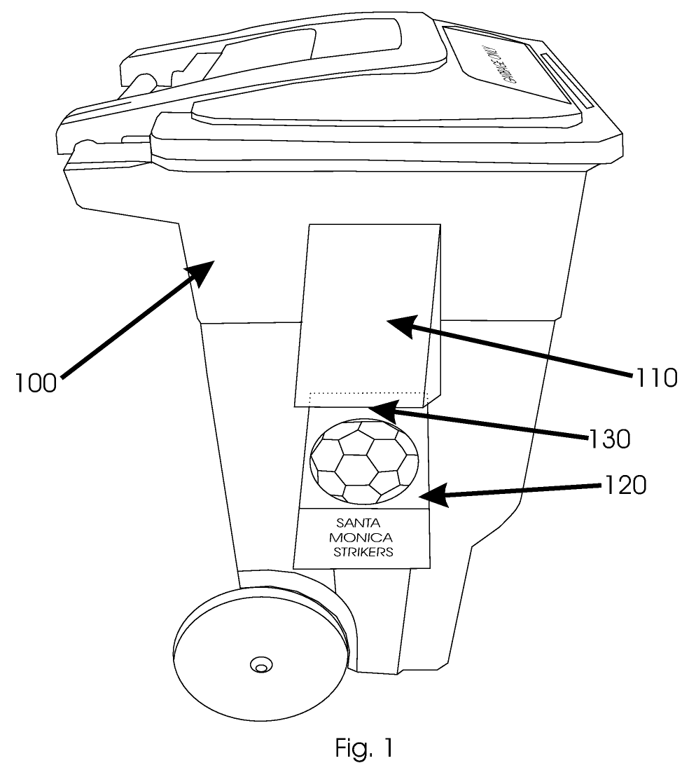

FIG. 1 shows one preferred embodiment wherein a 30-60 gallon trashcan or recycling bin 100 made of either metal or plastic is used. A display pocket 110 is provided in the form of a transparent envelope of suitable dimensions (e.g., 9″×12″, 19″×25″, etc.) and having an adhesive backing. A display sheet 120 bearing the promotional image is shown being inserted therein. The user can buy the envelope with adhesive backing and can provide a promotional image of their choice to insert into the envelope. The envelope can be affixed to the can or bin with waterproof adhesive pre-applied to the envelope (e.g., using four stripes of adhesive or double-sided tape for secure fastening and protected by removable backing strips to allow for easy installation). A promotional image is shown on the printed sheet 120, which is inserted into the envelope 110 for display.

In particular embodiments, the size of the display pocket and the display sheet can vary, limited only by the practical constraints of the size of the receptacle to which it is to be applied. A user will most likely choose a display pocket and sheet size commensurate with the can size, in some embodiments as large as will conveniently fit, but such is not a requirement. It can be much smaller if desired. It is also possible for a display pocket to be physically larger in at least one dimension than the receptacle to which it is applied.

Similarly, since receptacles vary widely in shape and can have tapered, curved, or corrugated surfaces, it is not a requirement that the display pocket be in intimate contact with the surface of the receptacle, but merely that there be sufficient contact to secure the pocket. For example, in the case of a predominantly cylindrical receptacle, the display pocket can be bent to conform with the curvature of the receptacle, or it can be in contact with a vertical strip extending down the side of the receptacle such that the curvature (if any) of the display pocket with promotional image inserted therein does not match the curvature of the receptacle. Other alternative forms of contact can be readily envisioned and are included within the scope of the invention.

In certain embodiments, the shape of the display pocket and/or sheet can be other than rectangular. For example, the outer shape of the promotional image, or of the display pocket, or both, can be round or oval or can conform to the outline of a logo such as a football, basketball, or baseball; or a company logo or team mascot.

The display pocket can be made in the form of an envelope made of flexible material or as a rigid structure made of stiff material. The entire display pocket can be transparent, or it can comprise both opaque material and a window through which the display sheet can be seen.

The opening in the display pocket 110 for insertion of the display sheet can be in any convenient location. The opening can optionally include a protective flap or cover to prevent water and dirt from entering the pocket, and securing means to secure the promotional material inside the pocket. The opening can further include a locking means to prevent tampering. The embodiment illustrated in FIG. 1 shows the opening 130 on the bottom of the display pocket 110, which can prevent the pocket from collecting water from rain. In this embodiment, means are provided to either close the bottom of the pocket 130, or to support the display sheet so that it cannot fall out of the pocket.

In yet further embodiments, the means for affixing the display pocket to the waste receptacle can be chosen from any of many well-known means. These include any suitable adhesives, either pre-applied to the pocket or applied by the user. Durable adhesives can be used to provide near-permanent attachment. In certain embodiments, it is preferable to use temporary adhesives which allow for easy replacement of the display pocket. The means for affixing the display pocket to the waste receptacle can also utilize other forms of fasteners, such as, but not limited to, welds, screws, bolts, rivets, clips, hooks, wire, string, and rope made of any suitable material, and the like. Again, the permanency of the attachment can vary. A simple pair of hooks attached to the top of a receptacle or to holes in a side of a receptacle could allow for very rapid swapping of pockets; rivets or welds can make a much more permanent attachment limiting the potential for theft, for example, if such were an issue.

In further embodiments, the material from which the display pocket is made can vary. Any suitable engineering plastic (e.g., nylon, polyamide, polyethylene, polypropylene, polyurethane, polystyrene, vinyl, or copolymers thereof), wood, or even sheet metal (e.g., alloys of steel, aluminum, and tin) can be used. Less durable materials such as paper products (e.g., cardboard) can be utilized if durability is not desired. In preferred embodiments, the display pocket is UV-resistant to improve the color stability during prolonged exposure to sunlight. In addition embodiments, the display window absorbs UV to protect the promotional image from damage from sunlight.

The display sheet can be any suitable promotional image that can be inserted into the display pocket (which, in turn, can be sized to hold a promotional image of any suitable dimensions). Typical examples include images printed on paper, cardstock, poster board, plastic, and the like. Hand drawn or painted images can also be used. In preferred embodiments, the colorants used in the promotional image are UV-resistant to improve the color stability of the image during prolonged exposure to sunlight.

The display sheet can also have three-dimensional structure (for example, a three-dimensional seal or medallion). The display sheet can also comprise an active display device such as a graphics display device or digital picture frame, or otherwise incorporated moving or changing elements.

In yet another embodiment, the promotional image is an integral part of the waste receptacle. The promotional image can be printed or painted onto and/or embossed or molded into the material of the receptacle. For example, a molded plastic receptacle can have an image molded into the outer surface. Colored plastic can be incorporated into the molding process. Multiple colors can be used. Indeed, if color is an important part of the promotional image (as for example, team or school colors), the entire receptacle can become part of the display by use of the relevant color or colors. It is also possible to embed pre-manufactured medallions or plaques into the receptacle during molding. In embodiments of this paragraph, the user would purchase a new waste receptacle with the promotional image already applied.

Regardless of the manufacturing details, there are a wide variety of specific promotional and advertising applications to which the methods and apparatuses of this invention can be applied. Examples given here are meant to be illustrative; any promotional image may be displayed as long as it is unrelated to the functional purpose of the waste receptacle (i.e., to the storage and transfer of trash and material for recycling).

In one embodiment, for example, the promotional image is used to promote pride or team spirit, as for example, for a professional or school sports team. Such teams can include professional sports such as football, baseball, basketball, soccer, golf, Nascar, etc.; high school, college, and university teams, community teams, and international teams. The promotional image might include team colors, name, mascot, logo, slogan, images of team members, images related to the sport, and special timely messages (e.g., “Beat Cal,” etc.).

In another embodiment, the promotional image is used to promote a political candidate, party, or message. Any of the information that might be displayed on a lawn sign, poster, bumper sticker, or button during a political campaign can also be displayed on a waste receptacle.

In another embodiment, the promotional image is used to promote pride among an identified interest group. Examples of such interests include shared common heritage or ethnicity, shared religious affiliation, shared sexual orientation, shared employer or department, etc.

In another embodiment, the promotional image is used to promote pride among members of an identified club or association. Examples of such clubs or associations include school clubs and groups (music groups, game clubs, theater groups, interscholastic academic teams, etc.), and community interest groups of all sorts.

In another embodiment, the promotional image is used to advertise products and/or services or market a company. Such products and services might include, but are not limited to food, drinks, amusement parks, restaurants, manufactured goods, professional services, movies, theatrical entertainment, musical performances, and the like.

In another embodiment, the promotional image is used to support fan interest in celebrities, both real and fictional. Examples of such celebrities include, but are not limited to sports heroes; movie stars; TV and radio stars; cartoon characters; war heroes; characters in books, movies, and TV shows; famous musicians; politicians; and public figures.

In another embodiment, the promotional image is used to support fan interest in movies, TV and radio shows, music, theatrical entertainment, TV and radio stations and the like. Examples of display includes, but is not limited to images of performers, stars, characters, scenes, performance schedules, upcoming special events and the like.

In another embodiment, the promotional image is used to promote a fundraising activity. Examples of such activities include, but are not limited to civic projects, church projects, schools and school clubs, political causes, and the like.

In another embodiment, the promotional image is used to show pride in one's family. Examples of images that could be displayed include, but are not limited to pictures of family members, pets, and the like.

In another embodiment, the promotional image is used to show pride in and to market community, state, or country. Examples of images that could be displayed include, but are not limited to flags, seals, local landmarks and symbols, slogans, images related to tourism promotion, and the like.

In another embodiment, the promotional image is used to make a personal statement. The content and format of such a statement is limited only by the user's imagination, but examples include images with personal meaning such as scenes of nature, symbols of personal interests (animals, musical instruments, symbols related to employment or expertise, etc.), personal artwork, etc.

It is to be understood that the claims are not limited to the specific embodiments described herein but can include any embodiment, variation, or application that a person of ordinary skill would recognize as being obvious in light of the teachings herein.

What is claimed is:

1. An apparatus for displaying promotional material, comprising a waste receptacle and a promotional image displayed thereon.

2. The apparatus of claim 1, wherein said promotional image is unrelated to the storage or transfer of waste material.

3. The apparatus of claim 1, wherein said promotional image is an integral part of said waste receptacle.

4. The apparatus of claim 1, wherein said waste receptacle further comprises one or more display pockets molded into or affixed to said waste receptacle, and wherein said promotional image is displayed by inserting the promotional material into the display pocket such that the promotional image is visible from outside said pocket.

5. The apparatus of claim 1, wherein said promotional image is displayed on one or more sides of said waste receptacle.

6. The apparatus of claim 1, wherein said promotional image is displayed on the top or lid of said waste receptacle.

7. The apparatus of claim 1, wherein said waste receptacle is of a size suitable for use by an individual household, house, townhouse, apartment, or condominium.

8. The apparatus of claim 1, wherein said waste receptacle is of a size suitable for a collection of households or a business or construction site.

9. The apparatus of claim 8, wherein said waste receptacle is a dumpster.

10. The apparatus of claim 4, wherein means for affixing the said display pocket to said waste receptacle is selected from adhesives, welds, screws, bolts, rivets, clips, hooks, wire, string, or rope.

11. The apparatus of claim 3, wherein said promotional image is molded or embossed into the material of said waste receptacle.

12. The apparatus of claim 3, wherein said promotional image is printed or painted onto the surface of said waste receptacle.

14. A method of promotion, comprising displaying a promotional image on a waste receptacle.

15. The method of claim 14, wherein said promotional image is unrelated to the storage or transfer of waste material.

16. The method of claim 14, wherein said displaying a promotional image comprises providing a display pocket molded into or affixed to said waste receptacle and inserting promotional material into said display pocket, wherein said display sheet is visible from outside said display pocket.

17. The method of claim 14, wherein said promotional image is an integral part of said waste receptacle.

18. The method of claim 17, wherein said promotional image is molded or embossed into the material of said waste receptacle.

19. The method of claim 17, wherein said promotional image is printed or painted onto the surface of said waste receptacle.

20. An apparatus for displaying promotional material, comprising a waste receptacle and a promotional image displayed thereon, wherein said promotional image is unrelated to the storage or transfer of waste material, wherein said waste receptacle further comprises one or more display pockets molded into or affixed to said waste receptacle, and wherein said promotional image is displayed by inserting the promotional material into the display pocket such that the promotional image is visible from outside said pocket.
